(19) United States
(12) Patent Application Publication
(10) Pub. No.: US 2024/0022097 A1
(43) Pub. Date: Jan. 18, 2024

(54) MULTI-BAY BATTERY CHARGER

(71) Applicant: MILWAUKEE ELECTRIC TOOL CORPORATION, Brookfield, WI (US)

(72) Inventors: Zachary Self, Nashotah, WI (US); Roque M. Corpuz, Jr., Sheboygan, WI (US); Benjamin Oliver Ryan Cabot, Milwaukee, WI (US); Brian A. Foster, Milwaukee, WI (US); Vann Jacques, Mequon, WI (US)

(21) Appl. No.: 18/256,847

(22) PCT Filed: Dec. 14, 2021
(86) PCT No.: PCT/US2021/063228

§ 371 Date: Jun. 9, 2023

Related U.S. Application Data
(60) Provisional application No. 63/127,474, filed on Dec. 18, 2020.

(51) Int. Cl. H02J 7/00

(52) U.S. Cl. CPC H02J 7/0045; H02J 7/0013; H02J 7/0049

(57) ABSTRACT

A battery charger may include a housing including a plurality of battery bays and a plurality of charging indicators, each associated with a respective battery bay. The plurality of battery bays and the plurality of charging indicators may be located on an angled top side surface of the housing. The charger may be configured to be selectively mounted in a first position with a bottom side surface of the housing on a horizontal surface and in a second position with the bottom side surface on a vertical wall. The vertical wall may be approximately perpendicular to the horizontal surface. A viewing angle of the angled top side surface from a perspective along a horizontal plane parallel to the horizontal surface may be between approximately 120 degrees and approximately 150 degrees when the charger is located in either of the first position and the second position.

### RELATED APPLICATIONS

This application claims priority to U.S. Provisional Application No. 63/127,474, filed on Dec. 18, 2020, the entire contents of which are hereby incorporated by reference.

### FIELD

The present disclosure relates to multi-bay battery chargers, particularly to multi-bay battery chargers configured to charge single cell batteries.

### SUMMARY

One embodiment includes a battery charger that may include a housing including a plurality of battery bays. Each battery bay may be configured to receive a single cell battery. The battery charger may also include a mounting hole located on a bottom side surface of the housing. The mounting hole may be configured to receive a mounting fastener that has been mounted in a vertical wall to allow the battery charger to be mounted on the vertical wall. The battery charger may also include charging circuitry configured to charge the single cell battery. The battery charger may also include a Universal Serial Bus (USB) port configured to supply power to a USB device connected to the USB port. The battery charger may also include a plurality of charging indicators located on the housing. Each charging indicator may be associated with a respective battery bay of the plurality of battery bays. Each charging indicator may be configured to indicate a status of the single cell battery inserted in its respective battery bay. The plurality of battery bays and the plurality of charging indicators may be located on an angled top side surface of the housing. An angle of the angled top side surface with respect to a horizontal plane may be configured to be between approximately thirty degrees and approximately sixty degrees when the bottom side surface is located in a first position on a horizontal surface and when the bottom side surface is located in a second position mounted to the vertical wall.

Another embodiment includes a battery charger that may include a housing including a plurality of battery bays. Each battery bay may be configured to receive a single cell battery. The battery charger may further include a mounting hole located on a bottom side surface of the housing. The mounting hole may be configured to receive a mounting fastener that has been mounted in a vertical wall to allow the battery charger to be mounted on the vertical wall. The battery charger may further include charging circuitry configured to charge the single cell battery. The battery charger may further include a plurality of charging indicators located on the housing. Each charging indicator may be associated with a respective battery bay of the plurality of battery bays. Each charging indicator may be configured to indicate a status of the single cell battery inserted in its respective battery bay. The plurality of battery bays and the plurality of charging indicators may be located on an angled top side surface of the housing. A viewing angle of the angled top side surface from a perspective along a horizontal plane may be between approximately 120 degrees and approximately 150 degrees when the bottom side surface is located in a first position on a horizontal surface parallel to the horizontal plane and when the bottom side surface is located in a second position mounted to the vertical wall. The vertical wall may be approximately perpendicular to the horizontal plane.

Another embodiment includes a battery charger that may include a housing including a plurality of battery bays. Each battery bay may be configured to receive a battery. The battery charger may further include charging circuitry configured to charge the battery. The battery charger may further include a plurality of charging indicators located on the housing. Each charging indicator may be associated with a respective battery bay of the plurality of battery bays. Each charging indicator may be configured to indicate a status of the battery inserted in its respective battery bay. The plurality of battery bays and the plurality of charging indicators may be located on an angled top side surface of the housing. The charger may be configured to be selectively mounted in a first position with a bottom side surface of the housing on a horizontal surface and in a second position with the bottom side surface on a vertical wall. The vertical wall may be approximately perpendicular to the horizontal surface. A viewing angle of the angled top side surface from a perspective along a horizontal plane parallel to the horizontal surface may be between approximately 120 degrees and approximately 150 degrees when the charger is located in either of the first position and the second position.

Other aspects of the disclosure will become apparent by consideration of the detailed description and accompanying drawings.

### BRIEF DESCRIPTION OF THE DRAWINGS

FIGS. 1A-1D each illustrate a front top perspective view of a respective battery charger according to different example embodiments.

FIG. 2 illustrates a rear top perspective view of a charger according to one example embodiment.

FIG. 3 illustrates a front bottom perspective view of the charger of FIG. 2 according to one example embodiment.

FIG. 4 illustrates a side view of the charger of FIG. 2 mounted to a vertical wall according to one example embodiment.

FIG. 5 illustrates two of the same types of chargers where one charger is located on a horizontal table and another charger is mounted to a vertical wall according to one example embodiment.

FIG. 6 illustrates a left side view, a right side view, a front side view and a top side view of the charger of FIG. 2 according to one example embodiment.

FIG. 7 illustrates a back side view of the charger of FIG. 2 according to one example embodiment.

FIG. 8 illustrates a bottom side view of the charger of FIG. 2 according to one example embodiment.

FIG. 9 illustrates a side view of the charger of FIG. 2, according to one example embodiment, with a housing shown transparently to allow some internal components of the charger to be viewed.

FIG. 10 is a block diagram of the charger of FIG. 2 according to one example embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible. The terms “processor,” “central processing unit,” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

Throughout this application, the term “approximately” is used to describe the dimensions of various components. In some situations, the term “approximately” means that the described dimension is within 1% of the stated value, within 5% of the stated value, within 10% of the stated value, or the like. When the term “and/or” is used in this application, it is intended to include any combination of the listed components. For example, if a component includes A and/or B, the component may include solely A, solely B, or A and B.

Single cell batteries (e.g., single cell battery packs) may be used to power many different products including Universal Serial Bus (USB) rechargeable products such as personal and portable products such as personal and portable lighting products including flashlights, head lamps, and the like. Frequent users of such products may desire to repeatedly use and charge batteries in an organized and intuitive manner.

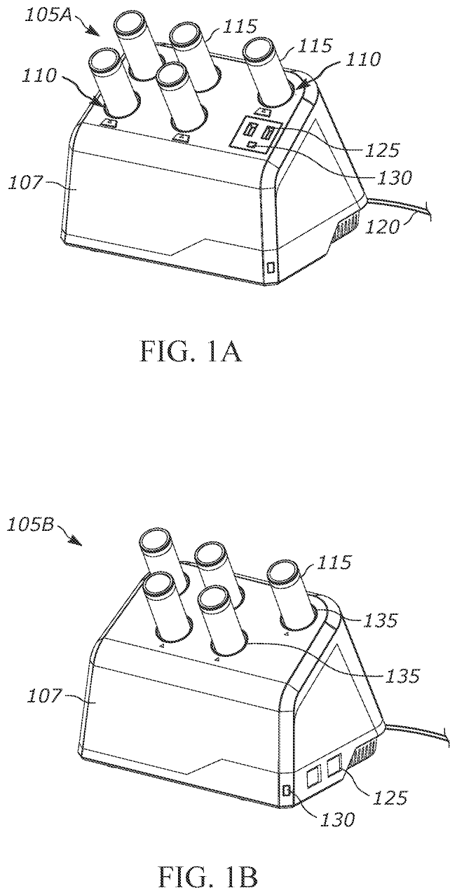

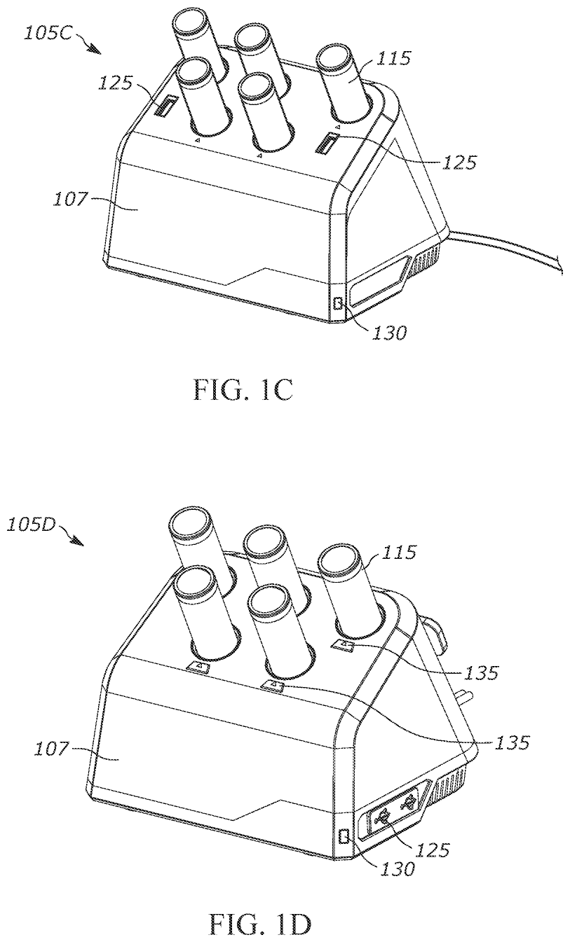

FIGS. 1A-1D each illustrate a front top perspective view of a respective battery charger 105A, 105B, 105C, and 105D (i.e., a single cell multi-bay battery charger) according to different example embodiments. In the following description, when explaining how a battery charger functions, a reference to charger 105 is used and may apply to any of the chargers 105A, 105B, 105C, and 105D shown in FIGS. 1A-1D.

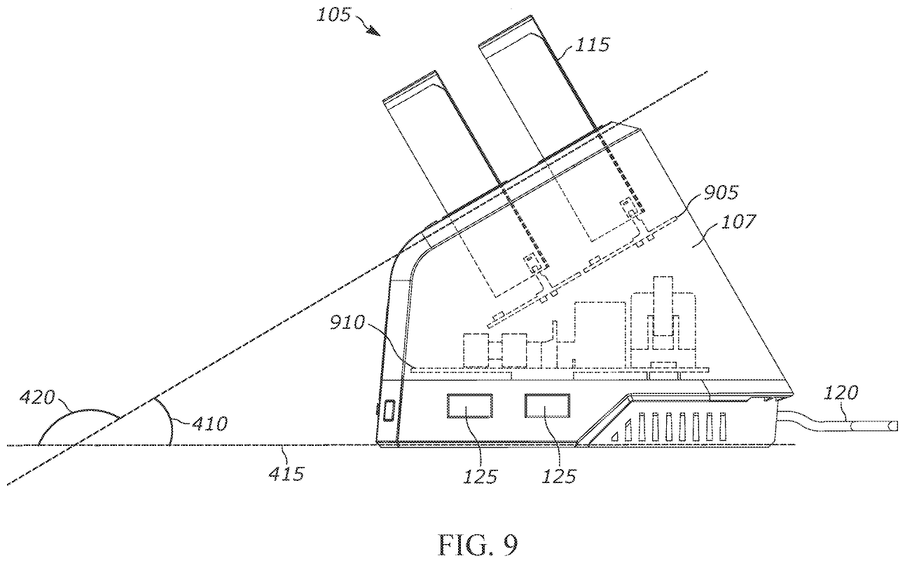

As shown in FIGS. 1A-1D, the charger 105 includes a housing 107 with five battery bays 110 that are each configured to receive a single cell battery 115. In some embodiments, the charger 105 may include more or fewer battery bays 110. As shown in FIGS. 1A-1D, in some embodiments, a battery 115 is longitudinally inserted into a battery bay 110 such that a portion of the battery 115 remains exposed outside of the housing 107. In some embodiments, over 50% of the battery 115 may remain exposed outside of the housing 107 while the battery 115 is charging (e.g., see FIG. 9). The portion of the battery 115 that remains outside of the housing 107 may be utilized for easy gripping by a user when removing the battery 115 from the charger 105. Also as shown in FIG. 9, a portion of the battery cell 115 may be surrounded by a battery bay 110 (i.e., not exposed outside of the housing 107) while the battery 115 is charging (e.g., approximately 30%, approximately 20%, approximately 10% or the like). In some embodiments, the portion of the battery cell 115 surrounded by the battery bay 110 during charging may allow the battery cell 115 to be securely held in the battery bay 110. In some embodiments, each battery bay 110 includes a first interface configured to physically and electrically couple to a second interface of the battery cell 115 (e.g., to allow current to flow from the charger 105 to the battery cell 115 to charge the battery cell 115).

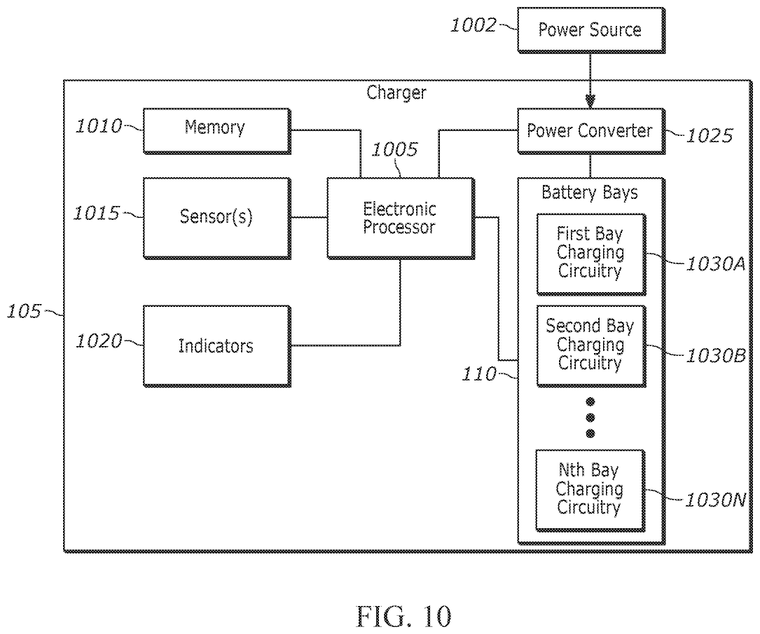

In some embodiments, the charger 105 includes a power cord 120. The power cord 120 may include an alternating current (AC) plug that is configured to receive AC power from a power source 1002 (see FIG. 10). The power source 1002 may be, for example, a single AC line voltage or a universal AC line voltage. The power source 1002 may also be another type of power source, such as a solar panel, a wind turbine, a battery pack, an AC grid line, or the like.

In some embodiments, the charger 105 includes USB output ports 125 that may be configured to supply power to a USB device when the charger 105 is connected to the power source 1002. In different embodiments, the USB ports 125 may be located in different areas of the housing 107. For example, FIG. 1A shows the USB ports 125 located together on a top surface of the charger 105 and adjacent to the battery bays 110. As another example, FIG. 1C shows the USB ports 125 located separately from each other but still on the top surface of the charger 105 and adjacent to the battery bays 110. As yet another example, FIGS. 1B and 1D show the USB ports 125 located on a side surface of the charger 105 near a bottom/base of the charger 105. In some embodiments, the charger 105 may include a power indicator light 130 (e.g., a light emitting diode (LED)) configured to indicate when the charger 105 is connected to the power source 1002 (i.e., to indicate when power is available to be provided by the USB ports 125 and/or the battery bays 110). The power indicator light 130 may be located in different locations of the housing 107 according to different embodiments as shown in FIGS. 1A-1D.

In some embodiments, the charger 105 also includes charging indicators 135 (e.g., LED(s)) for each battery bay 110. The charging indicators 135 may be configured to indicate a status of the battery 115 located in the battery bay 110. For example, a charging indicator 135 illuminated to be green or illuminated to constantly emit light may indicate that the battery 115 in the respective battery bay 110 is fully charged. As another example, a charging indicator 135 illuminated to be orange or illuminated to be flashing at a certain frequency may indicate that the battery 115 in the respective battery 110 is currently charging. As another example, a charging indicator 135 illuminated to be red or illuminated to be flashing at a certain different frequency may indicate that the battery cannot be charged, is not currently being charged, or some other battery error. The charging indicators 135 may be located at different locations of the housing 107 according to different embodiments. For example, FIGS. 1A-1C show the charging indicators 135 located circumferentially around an edge of the battery bays 110 (e.g., in the form of a ring). For example, a ring-shaped lens or light guide may be used to distribute light from one or more LEDs used as a charging indicator 135 for each battery bay 110. Alternatively, FIG. 1D shows the charging indicators 135 as a trapezoidal shape adjacent each battery bay 110. In this embodiment, the trapezoidal shape may also be provided by a lens or light guide used to distribute light from one or more LEDs used as a charging indicator 135 for each battery bay 110.

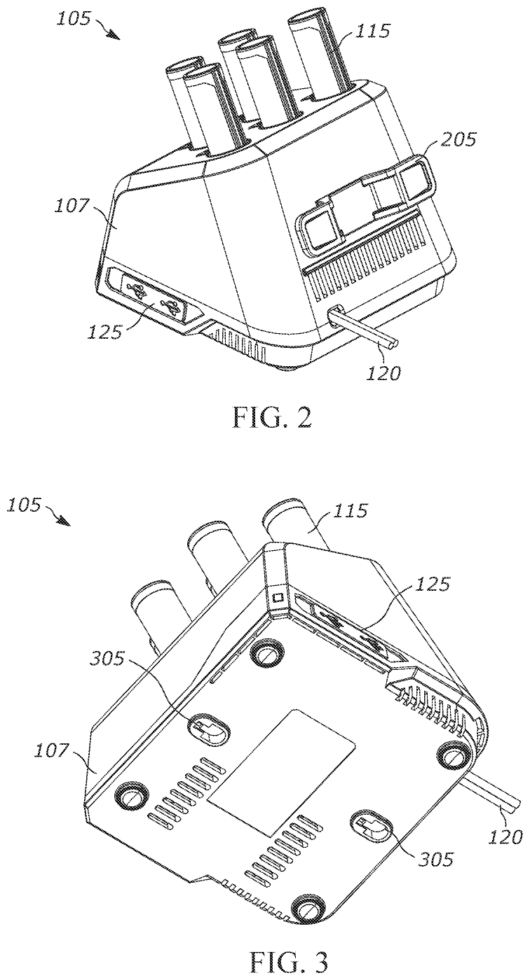

FIG. 2 illustrates a rear top perspective view of the charger 105 according to one example embodiment. As shown in FIG. 2, a rear side surface of the housing 107 may include a cord holder 205 around which a portion of the power cord 120 may be wound.

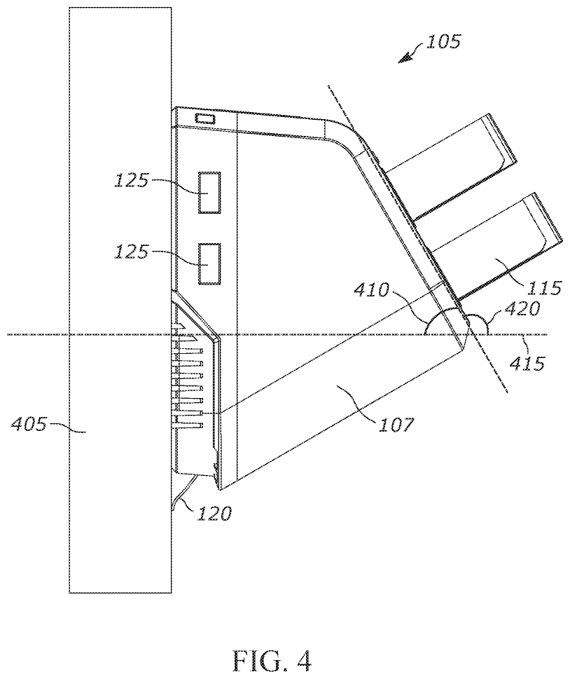

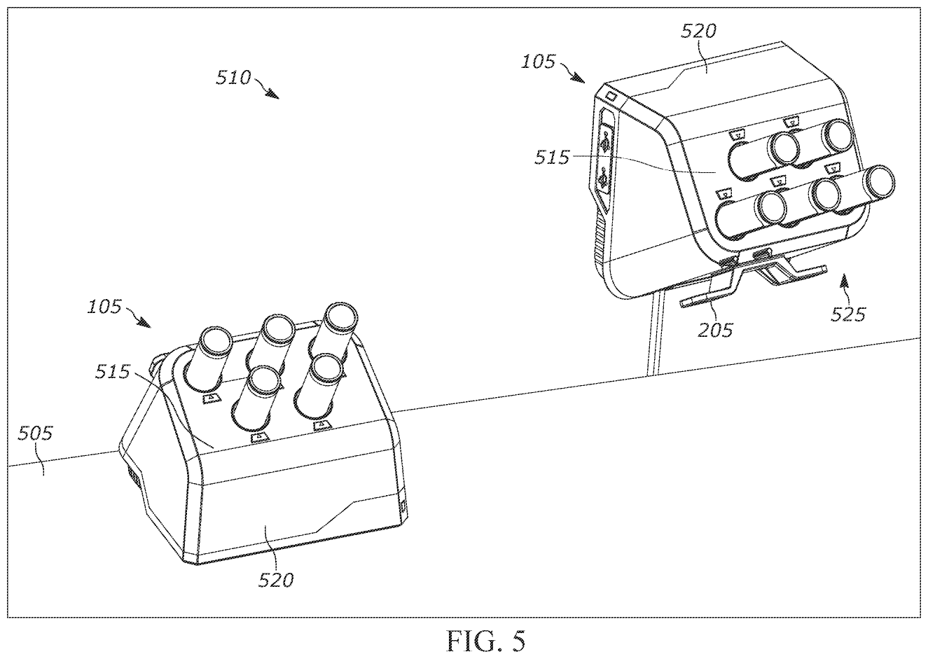

FIG. 3 illustrates a front bottom perspective view of the charger 105 according to one example embodiment. As shown in FIG. 3, a bottom side surface of the housing 107 may include one or more mounting holes 305. The mounting holes 305 may be configured to allow the charger 105 to be mounted on a vertical wall 405 as shown in FIG. 4. For example, mounting fasteners such as screws may be inserted into the wall 405 and the charger 105 may be hung on the mounting fasteners using the mounting holes 305. In some embodiments, other means may be used to mount the charger 105 to the wall 405 in addition to or as an alternative to the mounting holes.

FIG. 5 illustrates two of the same types of chargers 105 where one charger 105 is located on a horizontal table 505 and another charger 105 is mounted to a vertical wall 510. As shown in FIG. 5, in either orientation, the chargers 105 provide an angled top side surface 515 of the housing 107 to thereby provide easy visibility of the charging indicators 135 by a user and easy manipulation of the batteries 115 into and out of the battery bays 110 by a user. As shown in FIG. 5, in some embodiments, the angle of the top side surface 515 for the chargers 105 in either mounting position is similar with respect to the perspective of the user. For example, as indicated in the side views shown in FIGS. 4 and 9, an angle 410 of the top side surface 515 of the charger 105 with respect to a horizontal line/plane 415 parallel to the table 505 and perpendicular to the wall 510 may be between approximately 30 degrees and approximately 60 degrees in either mounting position of the charger 105. In some embodiments, the angle 410 of the top side surface 515 of the charger 105 with respect to the horizontal line 410 parallel to the table 505 and perpendicular to the wall 510 may be approximately 45 degrees in either mounting position of the charger 105. In other words, a viewing angle 420 of the top side surface 515 of the charger 105 from a perspective of a user along the horizontal line/plane 415 may be between approximately 120 degrees and approximately 150 degrees in either mounting position (or may be approximately 135 degrees in either mounting position according to some embodiments). Also as shown in FIG. 5, the charger 105 may be configured to be wall mounted on the vertical wall 510 such that a front side surface 520 of the housing 107 faces upward (i.e., away from the ground/direction of gravity) while a rear side surface 525 faces downward (i.e., toward the ground/direction of gravity).

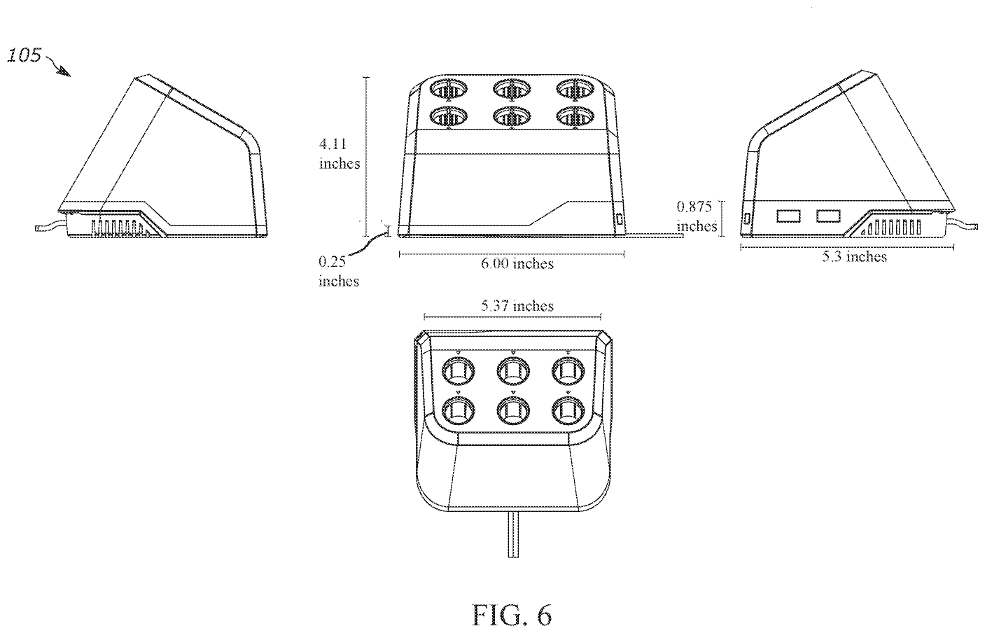

FIG. 6 illustrates a left side view, a right side view, a front side view and a top side view of the charger 105 according to one example embodiment. FIG. 6 also indicates example dimensions of the housing of the charger 105 according to one example embodiment. In some embodiments, the example dimensions are approximate dimensions. In some embodiments, the dimensions of the charter 105 may be different than those shown in FIG. 6.

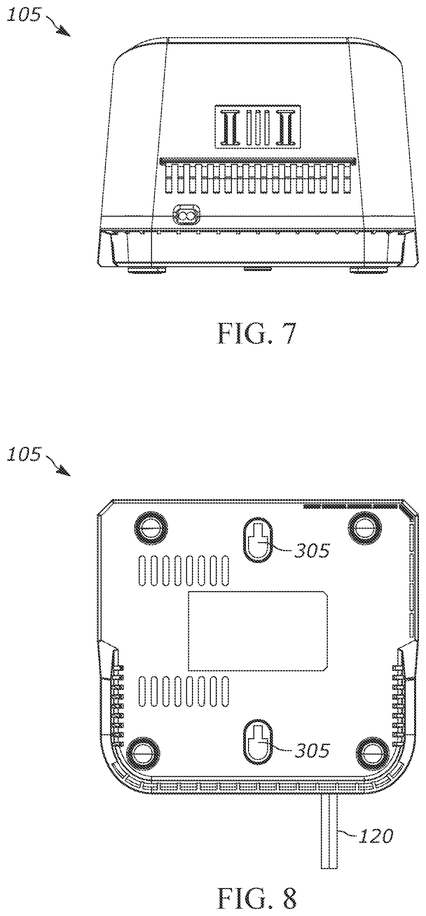

FIG. 7 illustrates a back side view of the charger 105 according to one example embodiment. In FIG. 7, the cord holder 205 is not shown.

FIG. 8 illustrates a bottom side view of the charger 105 according to one example embodiment.

FIG. 9 illustrates a side view of the charger 105 with the housing 107 shown transparently to allow some internal components of the charger 105 to be viewed. As shown in FIG. 9, the charger 105 may include a first printed circuit board (PCB) 905 on which terminals are mounted to electrically couple the charging circuitry of a battery bay 110 to a battery 115 inserted into the battery bay 110. The charger 105 may also include a second PCB 910 that may include the charging circuitry for each battery bay 110 and/or other electrical components such as power conditioning circuitry and/or an electronic processor. Although not shown in FIG. 9, the first PCB 905 and the second PCB 910 may be electrically connected to each other.

FIG. 10 is a block diagram of the charger 105 according to one example embodiment. In the example shown, the charger 105 includes an electronic processor 1005 (for example, a microprocessor or another electronic device). The electronic processor 1005 may include input and output interfaces (not shown) and may be electrically connected to a memory 1010, one or more sensors 1015, one or more indicators 1020, a power converter 1025, and charging circuitry 1030A-1030N of the battery bays 110.

The memory 1010 includes read only memory (ROM), random access memory (RAM), other non-transitory computer-readable media, or a combination thereof. The electronic processor 1005 is configured to receive instructions and data from the memory 1010 and execute, among other things, the instructions.

Power received from the power source 1002 is converted into a specific type of power usable by the charger 105 via a power converter 1025. For example, the power source 1002 may be an AC power source and the power converter 1025 may be an AC/DC converter that converts the AC power into DC power usable by the electronic processor 1005, the charging circuitry 1030, and/or USB output ports 125. As another example, the power source 1002 may be a DC power source and the power converter 1030 may be a DC/DC converter such as a buck-boost converter that converts the received DC power into DC power usable by the electronic processor 1005, the charging circuitry 1030, an/or the USB output ports 125.

The electronic processor 1005 may be configured to control the charging circuitry 1030 to control charging of the battery 115 in each battery bay 110. For example, power provided by the power converter 1025 to each charging circuit 1030 may be controlled by the electronic processor 1005. As indicated in FIG. 10, in some embodiments, each battery bay 110 may include separate charging circuitry 1030 that is individually controlled by the electronic processor 1005. In some embodiments, the charger 105 may be configured to simultaneously charge multiple batteries 115 (e.g., five batteries 115) using the separate charging circuitry 1030 of each battery bay 110.

In some embodiments, the sensor(s) 1015 include a temperature sensor, a current sensor, a voltage sensor, and/or the like. The sensor(s) 1015 may include sensors that detect the presence of a battery 115 in each battery bay 110. In some embodiments, the indicators 1020 include the power indicator light 130 and the charging indicators 135 shown in FIGS. 1A-1D and explained previously herein. The electronic processor 1005 may be configured to receive sensor data from the sensor(s) 1015 and may be configured to control an output of the indicators 1020.

The embodiments described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention.

We claim:

1. A battery charger comprising:
a housing including a plurality of battery bays, wherein each battery bay is configured to receive a single cell battery;
a mounting hole located on a bottom side surface of the housing, wherein the mounting hole is configured to receive a mounting fastener that has been mounted in a vertical wall to allow the battery charger to be mounted on the vertical wall;
charging circuitry configured to charge the single cell battery;
a Universal Serial Bus (USB) port configured to supply power to a USB device connected to the USB port;
a plurality of charging indicators located on the housing,
wherein each charging indicator is associated with a respective battery bay of the plurality of battery bays, and
wherein each charging indicator is configured to indicate a status of the single cell battery inserted in its respective battery bay;
wherein the plurality of battery bays and the plurality of charging indicators are located on an angled top side surface of the housing;
wherein an angle of the angled top side surface with respect to a horizontal plane is configured to be between approximately thirty degrees and approximately sixty degrees when the bottom side surface is located in a first position on a horizontal surface and when the bottom side surface is located in a second position mounted to the vertical wall.

2. The battery charger of claim 1, wherein a viewing angle of the angled top side surface from a perspective along the horizontal plane is between approximately 120 degrees and approximately 150 degrees when the bottom side surface is located in the first position and when the bottom side surface is located in the second position.

3. The battery charger of claim 1, wherein in the first position, the bottom side surface faces downward, a front side surface of the housing faces forward, and a rear side surface of the housing faces rearward; and
wherein in the second position, the bottom side surface faces rearward, the front side surface faces upward, and the rear side surface faces downward.

4. The battery charger of claim 1, wherein each of the charging indicators is located circumferentially around an edge of its respective battery bay.

5. The battery charger of claim 1, wherein each of the charging indicators is located underneath and adjacent to its respective battery bay.

6. The battery charger of claim 1, further comprising a cord holder located on the housing.

7. The battery charger of claim 6, wherein the cord holder is located on a rear side surface of the housing.

8. A battery charger comprising:
a housing including a plurality of battery bays, wherein each battery bay is configured to receive a single cell battery;
a mounting hole located on a bottom side surface of the housing, wherein the mounting hole is configured to receive a mounting fastener that has been mounted in a vertical wall to allow the battery charger to be mounted on the vertical wall;
charging circuitry configured to charge the single cell battery;
a plurality of charging indicators located on the housing,
wherein each charging indicator is associated with a respective battery bay of the plurality of battery bays, and
wherein each charging indicator is configured to indicate a status of the single cell battery inserted in its respective battery bay;
wherein the plurality of battery bays and the plurality of charging indicators are located on an angled top side surface of the housing;
wherein a viewing angle of the angled top side surface from a perspective along a horizontal plane is between approximately 120 degrees and approximately 150 degrees when the bottom side surface is located in a first position on a horizontal surface parallel to the horizontal plane and when the bottom side surface is located in a second position mounted to the vertical wall, wherein the vertical wall is approximately perpendicular to the horizontal plane.

9. The battery charger of claim 8, wherein in the first position, the bottom side surface faces downward, a front side surface of the housing faces forward, and a rear side surface of the housing faces rearward; and
wherein in the second position, the bottom side surface faces rearward, the front side surface faces upward, and the rear side surface faces downward.

10. The battery charger of claim 8, wherein each of the charging indicators is located circumferentially around an edge of its respective battery bay.

11. The battery charger of claim 8, wherein each of the charging indicators is located underneath and adjacent to its respective battery bay.

12. The battery charger of claim 8, further comprising a cord holder located on the housing, wherein the cord holder is located on a rear side surface of the housing.

13. The battery charger of claim 8, further comprising a Universal Serial Bus (USB) port configured to supply power to a USB device connected to the USB port.

14. A battery charger comprising:
a housing including a plurality of battery bays, wherein each battery bay is configured to receive a battery;
charging circuitry configured to charge the battery;
a plurality of charging indicators located on the housing,
wherein each charging indicator is associated with a respective battery bay of the plurality of battery bays, and
wherein each charging indicator is configured to indicate a status of the battery inserted in its respective battery bay;
wherein the plurality of battery bays and the plurality of charging indicators are located on an angled top side surface of the housing;
wherein the charger is configured to be selectively mounted in a first position with a bottom side surface of the housing on a horizontal surface and in a second position with the bottom side surface on a vertical wall, wherein the vertical wall is approximately perpendicular to the horizontal surface;
wherein a viewing angle of the angled top side surface from a perspective along a horizontal plane parallel to the horizontal surface is between approximately 120 degrees and approximately 150 degrees when the charger is located in either of the first position and the second position.

15. The battery charger of claim 14, wherein in the first position, the bottom side surface faces downward, a front side surface of the housing faces forward, and a rear side surface of the housing faces rearward; and
wherein in the second position, the bottom side surface faces rearward, the front side surface faces upward, and the rear side surface faces downward.

16. The battery charger of claim 14, further comprising a mounting hole located on the bottom side surface of the housing, wherein the mounting hole is configured to receive a mounting fastener that has been mounted in the vertical wall to allow the battery charger to be mounted on the vertical wall.

17. The battery charger of claim 14, wherein each of the charging indicators is located circumferentially around an edge of its respective battery bay.

18. The battery charger of claim 14, wherein each of the charging indicators is located underneath and adjacent to its respective battery bay.

19. The battery charger of claim 14, further comprising a cord holder located on the housing, wherein the cord holder is located on a rear side surface of the housing.

20. The battery charger of claim 14, wherein each battery bay is configured to receive a single cell battery.
